(19) United States
(12) Patent Application Publication
(10) Pub. No.: US 2011/0291444 A1
(43) Pub. Date: Dec. 1, 2011

(54) Quick changing rear module body vehicle

(76) Inventor: Timothy B. Ische, Eau Claire, WI (US)

(21) Appl. No.: 13/066,287

(22) Filed: Apr. 11, 2011

Related U.S. Application Data
(63) Continuation-in-part of application No. 12/313,035, filed on Nov. 17, 2008, now Pat. No. 7,922,238.

(51) Int. Cl. B62D 25/00; B23P 11/00; B62D 24/00

(52) U.S. Cl. 296/193.04; 296/35.1; 29/428

(57) ABSTRACT

A vehicle having a driver control region, such as a drive cab, and a specialized frame extending rearward from the driver control region and having a rear module body which can be easily exchanged on the specialized frame. The specialized frame has two rails, each with an incline or slope segment, and the rear module body has two open bottom frame channels, which conform to the rails and the inclines or slope segments thereof. When lowered onto the specialized frame, interaction between the specialized frame and frame channels creates a forward push resulting in a desired position of the rear module body rearward of driver control region. Optionally, the specialized frame may be provided by adaptors attached to a regular vehicle frame to provide a slope segment or incline. The vehicle may be based on a truck, such as a chassis-cab or upon an all-terrain-vehicle (ATV). A plurality of specialized rear module bodies may include box, closed container, or passenger oriented configurations.

### RELATED APPLICATIONS

This is a continuation-in-part of U.S. application Ser. No. 12/313,035 filed Nov. 17, 2008, now U.S. ______, the entire disclosure of which application is incorporated by reference herein.

### STATEMENT REGARDING FEDERALLY SPONSORED RESEARCH OR DEVELOPMENT

Not Applicable

### NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to vehicles having rear module bodies; and in particular, the present invention relates to vehicles with frames, the vehicles having rear module bodies which may be quickly changed.

2. Description of Related Art

Vehicles are a significant investment and sometime serve only a limited purpose. A passenger vehicle which serves effectively in transporting people is highly ineffective and inappropriate in transporting gravel or hay or grain. A cargo box on a pick-up truck sacrifices passenger capacity in order to maintain open cargo space for hauling gravel or hay or grain. It has long been desired to increase the range of useful tasks which can be accomplished with a single vehicle. One possible way to achieve more tasks with a single vehicle is by providing for interchangeable modular additions or accessories which, when temporarily installed allow new uses. Truck manufacturers market chassis-cabs which have driving cabs with flat frames and which are intended to receive permanently mounted aftermarket bodies.

Pick-up truck campers are well known as a convenient way to make a pick-up truck serve a second function as a camper, however, such campers are typically installed into the box or bed of pick-up trucks. An exemplary pick-up truck camper is disclosed by McCarthy, in U.S. Pat. No. 7,722,110, also incorporated by reference herein in its entirety. McCarthy teaches a wheel-less pick-up truck camper with internal jacks, normally residing in flush covered recesses, which jacks slide outward, carrying normally flush cover portions of camper wall. Once slid outward, the jacks are employed to lift McCarthy's camper vertically from the flat bottom of the pick-up truck bed, allowing the pick-up truck to drive away. Reinstallation of the McCarthy camper is a complete reversal of the process of lifting. That is, the camper must be appropriately positioned before being lowered to rest upon the flat bottom of the pick-up truck bed. While not discussed by McCarthy, the present inventor has experienced difficulty in appropriate positioning campers of this general type into pick-up trucks. For and aft positioning can be quite daunting when a tight fit of the camper to the front of the pick-up truck bed is to be achieved. If the pick-up travels too far rearward, cosmetic damage or even structural damage might result. If the pick-up travels insufficiently rearward, the desired tight fit may not be achieved and subsequent securing of the camper to the pick-up may be difficult.

The inventor has recognized that there remains a need for a single vehicle which a typical person can own and operate and upon which a typical person can easily exchange rear module bodies with various configurations and purposes to allow the vehicle to serve a number of various functions. Such a vehicle and two or more easily exchangeable rear module bodies, each having distinct capabilities, would avoid the expense of owning and maintaining two or more different vehicles. The present invention is believed to satisfy that need.

### SUMMARY

The present invention, in one embodiment, is a vehicle with a driving cab and a specialized frame extending rearward from behind the driving cab. The specialized frame has two rails, each with a top and sides and each rail has an inclined or sloped segment. A rear module body for the vehicle has two frame channels, each with an open bottom and each of which frame channels contours to the top and sides and inclined or sloped segments of the rails of the frame. When the rear module body is lowered onto the vehicle, the rails of the specialized frame and the frame channels of the rear module body interact to slide or push the rear module body forward into a tight fit with the driving cab of the vehicle. The rear module body is one of a plurality of such rear module bodies, each with a preferred purpose or function. For example, one rear module body might be a passenger style body and another might be a pick-up style box body and yet another rear module body a camper. The rear module body, when installed into the tight fit with the rear of the driving cab, may then fastened or locked in the installed position by fastening the frame channels to the rails of the frame.

Four sliding lock jack assemblies, carried in side compartments of the rear module body, extend through holes or apertures in the frame channels and rails to fasten the rear module body to the vehicle in a fastened, first condition, and deploy from the apertures to release the rear module body from the vehicle in a deployed, second condition. The sliding lock jack assemblies may be used to lift the rear module body from the vehicle when deployed. The sliding lock jack assemblies may also carry a body panel to conceal the sliding lock jack assemblies in the side compartments when fastened in the first condition. The sliding lock jack assemblies may also be rotated 90 degrees between the fastened first condition and the deployed second condition. This 90 degree rotation allows for a smaller vertical dimension in the side compartments, as compared to the above mentioned McCarthy camper type recesses, which must have a vertical dimension sufficient to accommodate a vertically oriented jack. The sliding lock jack assemblies may include a pump system to operate the jacks in lifting the rear module body which is powered with electricity supplied by the vehicle. The jacks can be electro-mechanical or electro-hydraulic in operation.

In another embodiment, the present invention is a quick changing rear module body vehicle including a base vehicle and a rear body module, exchangeably mountable on the base vehicle. The base vehicle includes a driver control region. The driver control region might be a driving cab in the case of a chassis-cab based vehicle or might be a seat and handle bars in the case of an all-terrain vehicle (ATV) base or a seat and steering wheel in the case of non-cab style vehicles or even a seat and control sticks for skid-steer style vehicles. Other potential sources of base vehicles include 2 wheel drive chassis-cab truck, 4×4 drive chassis-cab truck, all wheel drive chassis-cab truck, 6×6 drive trucks, 8×8 drive trucks, all-terrain-vehicle, utility-terrain-vehicle, skid-steer vehicles, track vehicles, agricultural vehicles, and military vehicles. The base vehicle also includes a specialized frame extending rearward from the driver control region. The specialized frame has a slope segment or incline which is lower toward the driver control region and higher further rearward from the driver control region. The rear module body is one of a plurality of rear module bodies, preferably with varied configurations and varied uses consistent with such configurations. Configurations for rear module bodies include regular cab pickup truck, extended cab pickup, crew cab pickup, flat bed truck, suv, van, crossover, and camper, as well as military ammunition and/or gun carriers. The rear module body has a bottom and a frame channel located on or at the bottom of the of the rear module body, the frame channel having U-shape oriented with an open bottom and contoured to fit the slope segment or incline of the specialized frame of the base vehicle. When the rear module body is vertically lowered onto the specialized frame of the base vehicle, the slope segment or incline of the specialized frame creates a forward push of the rear module body toward the driver control region, resulting in positioning of the rear module body in a desired position of the rear module body on the specialized frame rearward of the driver control region. In the case of a driving cab, the desired position may be a tight fit of the front of the rear module body to the rear of the driving cab. In the case of an ATV based vehicle, the desired position may be defined as situated for and aft at a position to create an appropriate for and aft balance or to create a desirable ergonomic condition or other suitable design criteria. Optionally, a stop or other indexing means may be provided to limit the forward movement from the forward push of the rear module body toward the driver control region and arrest the movement at the desired position. The stop blocks forward movement and in a preferred embodiment, the stop is a bolt head or clamp on the frame rail situated along the frame rail of the specialized frame at the farthest forward desired movement of the frame channel of the rear module body. Such a stop or other indexing means may be used to prevent a tight fit between a driving cab driver control region and a rear module body if desired.

In another embodiment, the present invention is an adapter for attachment to a rail of a vehicle frame. The adapter includes a rail interface, a slope segment elevated above the rail interface, and means for attaching the adapter to the rail. When a pair of the adapters are attached to the rails of a frame, the pair of adapters provide an adapted specialized frame, having two adapted frame rails, each adapted frame rail having a slope segment, the adapted specialized frame receptive of a rear module body with a bottom having two frame channels, the frame channels having a U-shape with an open bottom and contoured to fit the slope segments of the adapted frame rails of the adapted specialized frame, such that when the frame channels are aligned over the adapted frame rails and lowered onto the specialized frame, a forward push by the slope segments interacting with the contoured frame channels, such that a desired position results for the rear module body on the adapted specialized frame.

In another embodiment, the present invention is a method of assembly for a vehicle. The method includes the steps of: providing a base vehicle, providing a rear module body, aligning the rear module body with the base vehicle, lowering the rear module body onto the base vehicle, and creating a forward push by interactions between the rear module body and the base vehicle such that a desired position results for the rear module body on the base vehicle. The base vehicle has a driver control region and a specialized frame having two rectangular tubular rails, each with a slope segment or incline. The rear module body has a bottom having two frame channels, the frame channels having a U-shape with an open bottom and contoured to fit the slope segments or incline of the rails of the specialized frame. The aligning step includes aligning the frame channels over the rails of the specialized frame. The lowering step may be by jacks, or alternatively, by hand lowering in the case of smaller, lighter rear module bodies. In the case of jacks, the jacks may be attached to the rear module body or may be jacks which are independent of, but temporarily supporting, the rear module body. The forward push is created by the slope segments interacting with the contoured frame channels, such that a desired position results for the rear module body on the specialized frame of the base vehicle.

### BRIEF DESCRIPTION OF DRAWINGS

FIG. 1 schematically shows a side view of a base vehicle with a driving cab and an exposed frame system extending rearwardly.

FIG. 2 schematically shows a side view of the base vehicle of FIG. 1 with the driving cab with an exemplary rear module body attached and sliding lock jack assemblies in locked and stowed position.

FIG. 3 schematically shows a side view of the base vehicle of FIG. 1 with the driving cab and the exemplary rear module body readied for lifting by the sliding lock jack assemblies after detachment of locking tubes of the sliding lock jack assemblies from the frame rails and with the sliding lock jack assemblies in vertical deployed position. Alternatively, FIG. 3 schematically shows a side view of the base vehicle of FIG. 1 with driving cab and exemplary rear module body as having completed a two pathway portion of installation and readied to have the jacks further retracted and the locking tubes pushed in to lock the frame and frame channels together.

FIG. 4 schematically shows a side view of the free standing exemplary rear module body of FIGS. 2 and 3 being supported by the sliding lock jack assemblies.

FIG. 5 schematically shows a bottom view of a rear module body with emphasis upon the stowed location of sliding lock jack assemblies, and frame channels and schematically shows a pump system for operating the jacks of the sliding lock jack assemblies.

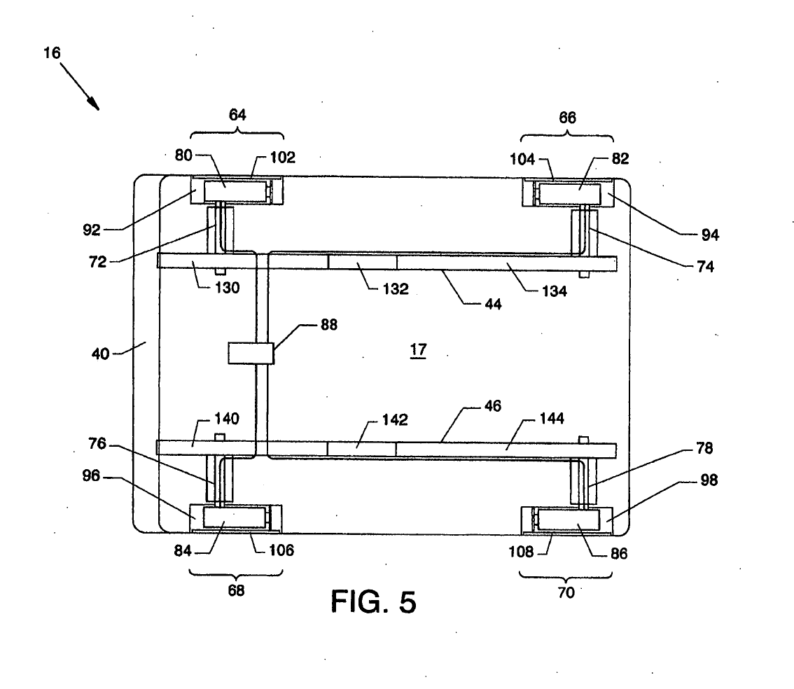

FIG. 6 schematically shows a detailed cross section view at 6-6 of FIG. 2 of stowed left rear sliding lock jack assembly, with the locking tube extending through holes or apertures in a fastening, first condition, thereby locking the frame of the base vehicle, rearward of the driving cab and axle, to the frame channel of the rear module body.

FIG. 7 schematically shows a side view of rear module body of FIG. 2 with frame channel and front sloping angle in dotted outline.

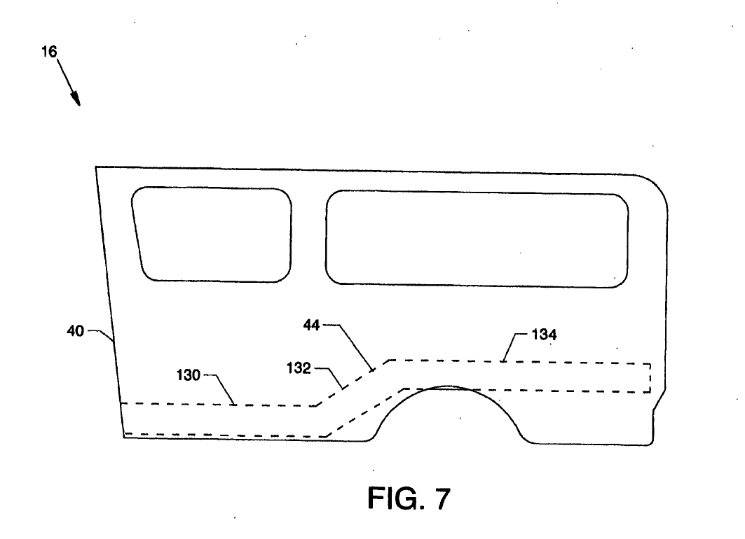

FIG. 8 schematically shows a bottom view of rear module body of FIG. 2 with frame channels and with sliding lock jack assemblies in stowed position.

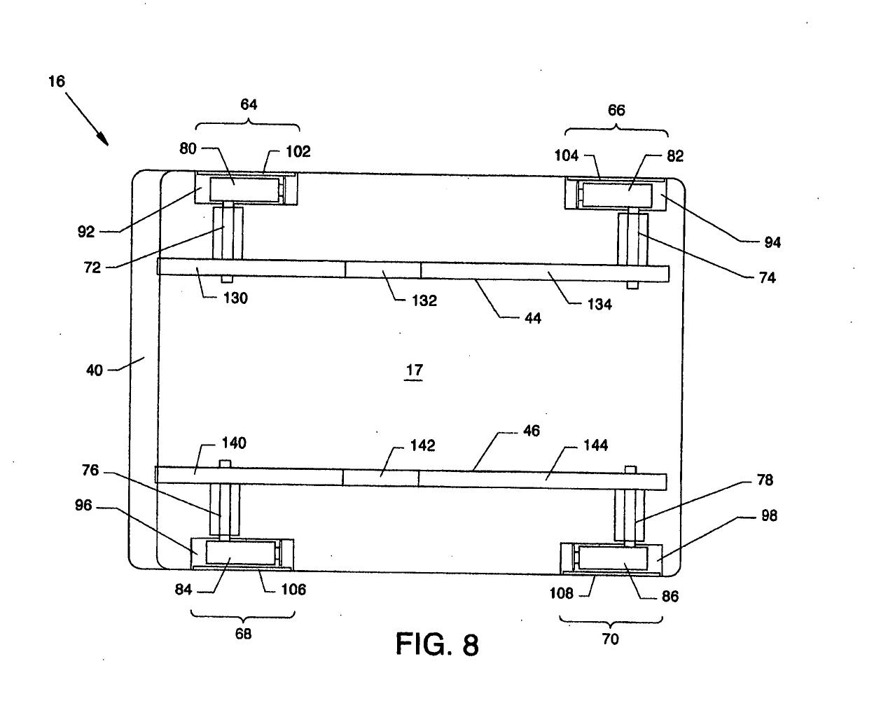

FIG. 9 schematically shows a cross section at 9-9 of FIG. 2 as a back view of rear module body and showing U-shaped frame channels.

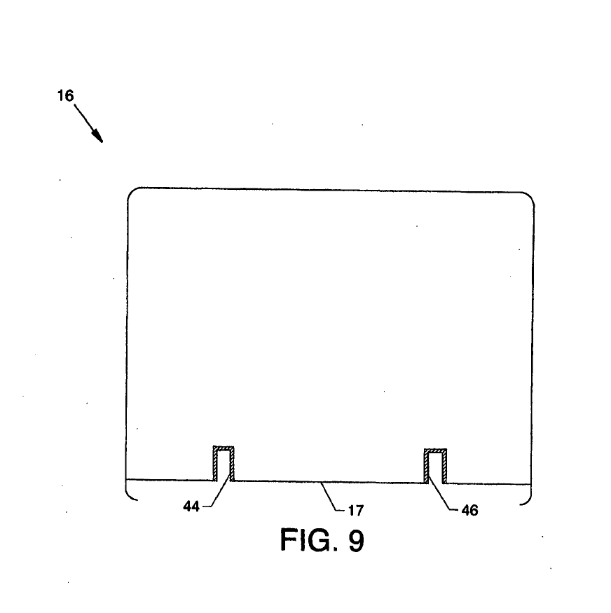

FIG. 10 schematically shows a cross section view at 10-10 of FIG. 2 of left rear sliding lock jack assembly, locking the rear module body to the frame of the vehicle rearward of the driving cab and rear axle, as well as showing the manual locking lever.

FIG. 11 schematically shows a cross section view at 11-11 of FIG. 3 of left rear sliding lock jack assembly deployed and also showing frame channels on the frame of the base vehicle rearward of the driving cab and rear axle.

FIG. 12 schematically shows another rear module body, with pick-up box configuration and functionality, installed on a base vehicle.

FIG. 13 schematically shows a cross section of the rear module body portion of FIG. 12 as a back view and showing U-shaped frame channels and a rear view window.

FIG. 14 schematically shows internal details of an embodiment of a left rear sliding jack assembly.

FIG. 15 schematically shows the distinct pathways of installation and removal of a typical rear module body onto and off from a base vehicle.

### DETAILED DESCRIPTION

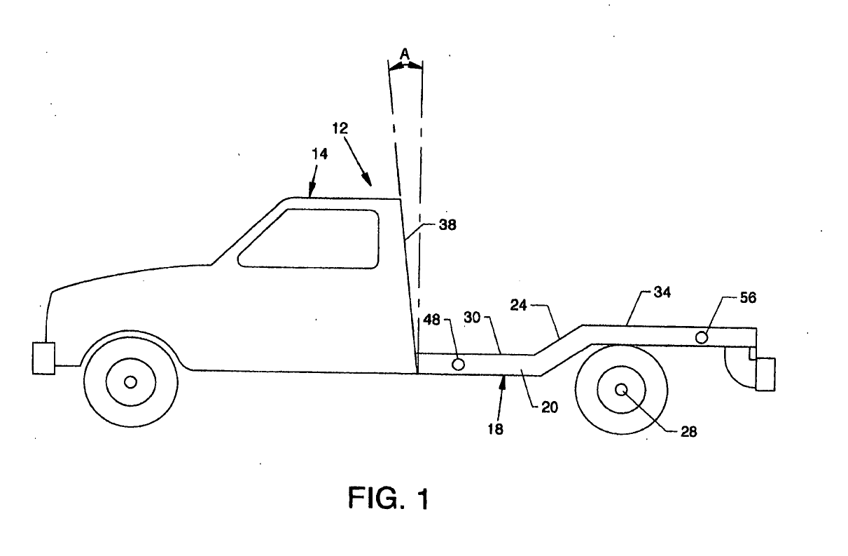

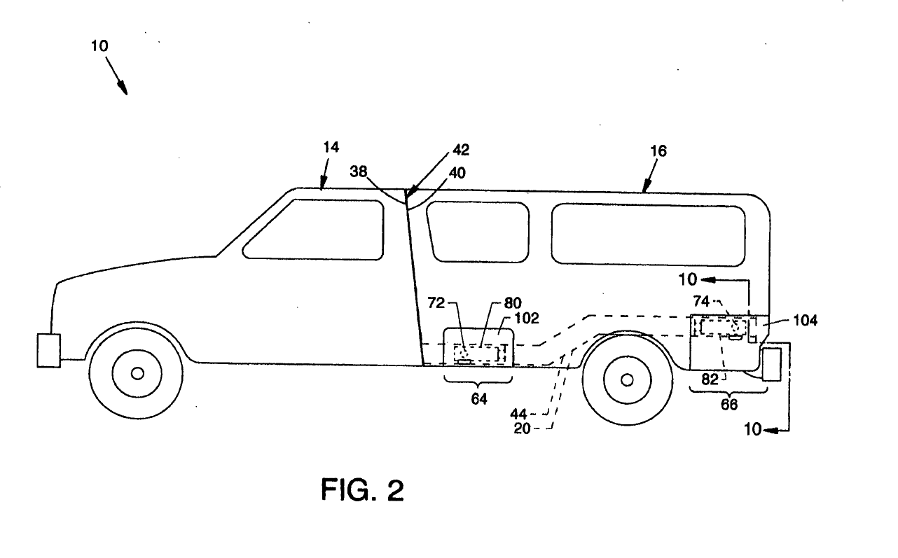

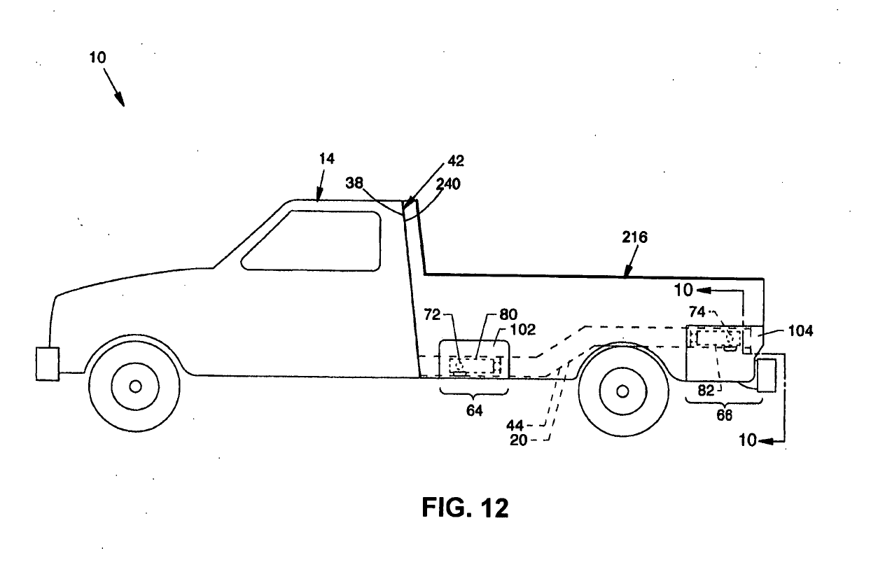

In a first embodiment, my invention is a quick changing rear module body vehicle 10. The quick changing rear module body vehicle 10 has two primary components, a base vehicle 12 with a driving cab 14, and a rear module body 16 which can be quickly changed upon the base vehicle 12. A passenger door, while present, is not shown on the driving cab 14. The rear module body 16 is exemplary of a passenger or SUV type rear module body 16 and therefore is schematically depicted with windows. Such a rear module body 16 might include passenger seating, either in a second row or a second and third row configuration and such seating might be fixed, fold-down to convert to cargo use, removable or any combination of these. The exemplary rear module body 16, if intended for passengers, might or might not have passenger doors, as the driving cab 14 passenger doors might be used for passengers entering or leaving second or third row seating, as is known for some two door SUV and some station wagons. A rear cargo door might or might not be provided, and if provided, such are well within the skill of the art, whether top hinged single door, top and bottom hinged double doors, single or double side hinged doors or dual acting doors, all with or without windows. Another rear body module 216 shown in FIG. 12 is exemplary of a pick-up box and will be discussed later. A floor, typically a flat floor, but optionally a formed or complex floor or bottom is present in these rear module bodies 16 and 216. The details of my invention starting at FIG. 1 shows the base vehicle 12 with the driving cab 14 and with a specialized frame 18 consisting of two rectangular tubular frame rails 20 and 22 extending rearward from the driving cab 14. These two rectangular tubular frame rails 20 and 22 would each have an upward slope or inclined segment 24 and 26 starting in front of the rear axle 28 and leveling above the rear axle 28 to the rear of the frame 18. In otherwords, a mid-segment 30 of left rectangular tubular frame rail 20 extends rearward from the driving cab 14 to the left inclined segment 24, which in turn, is connected to rear elevated segment 34. Note particularly that left inclined segment 24 is lower where it connects to mid-segment 30 and higher where it connects to rear elevated segment 34. The angle of this inclined segment is preferably from about 30 degrees to about 60 degrees relative to horizontal, and more preferably from about 40 degrees to about 50 degrees relative to horizontal, and most preferably about 45 degrees relative to horizontal. Similarly, mid-segment 32 extends rearward from the driving cab 14 to the right inclined segment 26, which in turn, is connected to rear elevated segment 36. The rear 38 of the driving cab 14 would preferably be open to allow the rear module bodies 16, which are also preferably open to the front 40, allowing both body sections driving cab 14 and rear module body 16 to be joined at a junction 42—as schematically depicted in FIG. 2. This junction 42 serves to provide a seal to the rear 38 of the driving cab 14 against the exterior weather, wind, and noise while driving. All rear module bodies 16 will have two frame channels 44 and 46 located on the bottom of the rear modular body 16. These frame channels 44 and 46 will be U-shaped, contouring and conforming precisely around the two rectangular tubular frame rails 20 and 22 leaving only the bottom side open. The channel frames 44 and 46 should also be understood to conform to the shape of the three segments of the rails including especially the inclined segments 24 and 26. This open frame channel design will allow for the lifting of the rear module bodies 16 off of the two rectangular tubular frame rails 20 and 22 of the specialized frame 18 extending rearward from the driving cab 14 of the base vehicle 12. Each rectangular tubular frame rail 20 and 22 rearward of the driving cab 14 will preferably have four mounting holes, two on the inside and two on the outside, corresponding with each other. In otherwords, mid-segment 30 of the left frame rail 20 has an outside aperture 48 and an inside aperture 50 which are co-aligned; mid-segment 32 of the right frame rail 22 has an outside aperture 52 and inside aperture 54 which are co-aligned; elevated rear segment 34 of left frame rail 20 has an outside aperture 56 and an inside aperture 58 which are co-aligned; and elevated rear segment 36 of right frame rail 22 has outside aperture 60 and inside aperture 62 which are co-aligned. These holes or apertures 48, 50, 52, 54, 56, 58, 60, and 62 would be located on the specialized frame 18 behind the driving cab 14 and behind the rear axle respectively.

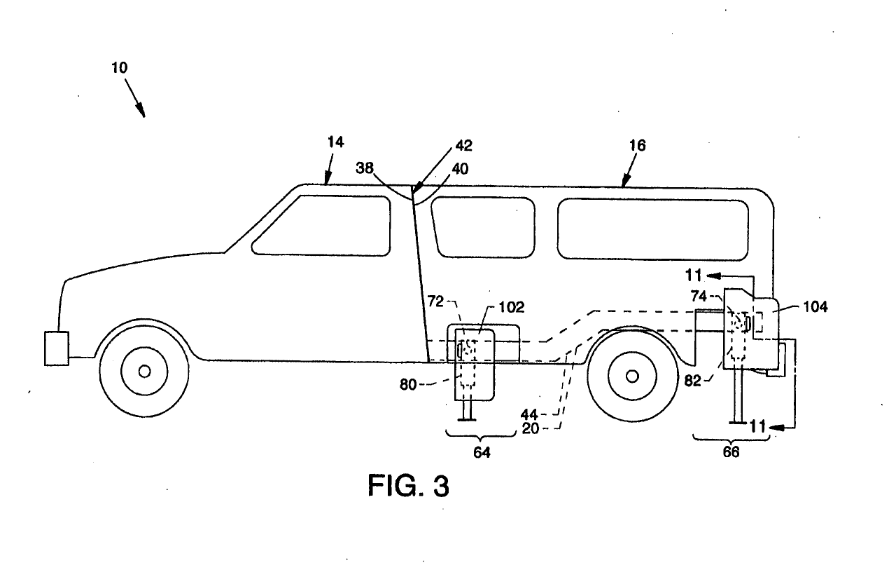

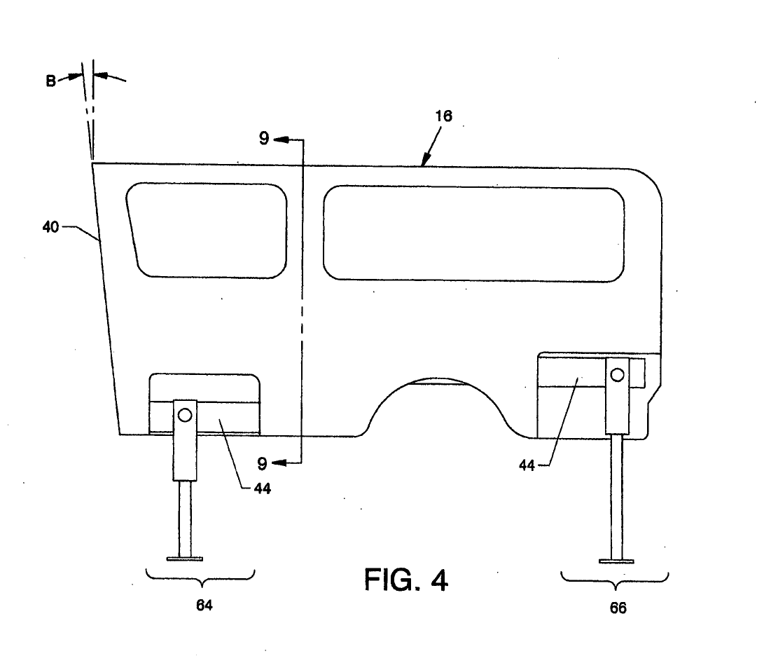

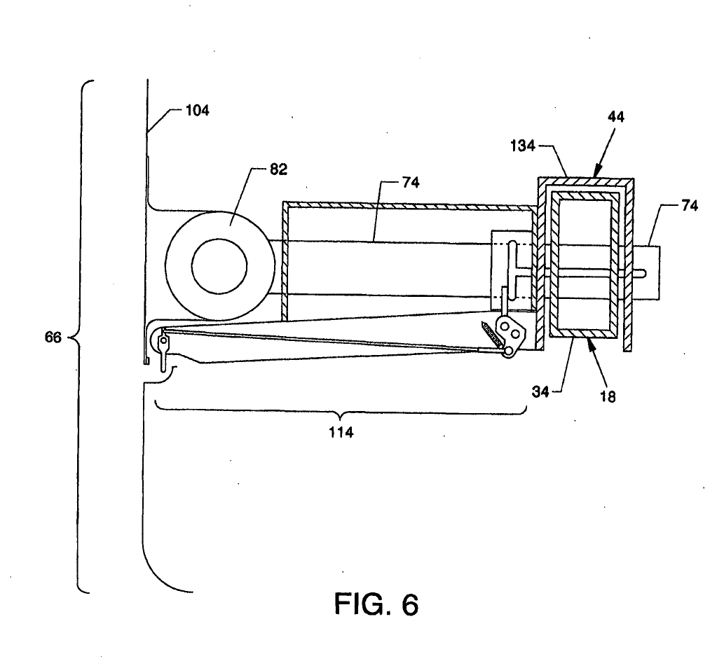

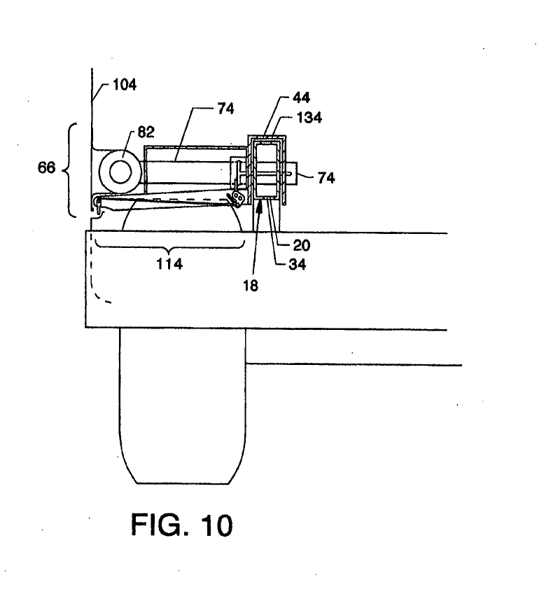

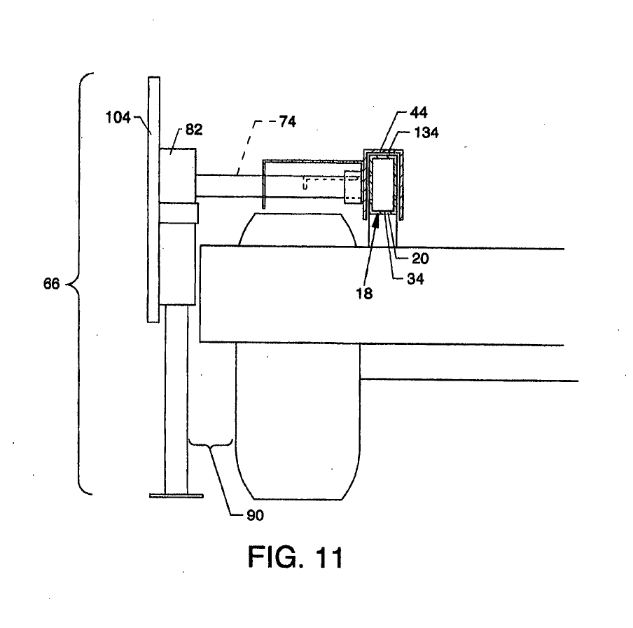

The rear module bodies 16 will be fitted with four sliding lock jacks 64, 66, 68, 70. The four sliding lock jacks 64, 66, 68, 70 each include locking tubes 72, 74, 76, 78 respectively. These locking tubes, for example, left rear 74 (of 72, 74, 76, 78) are shown in a locked position in FIG. 10 in which the locking tube 74 goes completely thru the outside and inside left rear apertures 56 and 58 of the elevated left rear segment 34 of the left rail 20 behind driving cab 14 and the specialized frame 18 and also completely through the rear module body frame channel 44. The unlocked position depicted in FIG. 11 shows the locking tube 74 completely disengaged from the specialized frame 18. These locking tubes 72, 74, 76, and 78 are each attached to the jacks 80, 82, 84, and 86, respectively. Each locking tube 80, 82, 84, and 86 on the jack system 88 will serve four purposes. The first purpose is the locking of the rear module body 16 to the specialized frame 18 which is showing as the locking tubes 80, 82, 84, and 86 extending thru both the frame channel 44 and 46 on the rear module body 16 and the specialized frame 18. As shown at FIG. 6 is the frame channel 44 and 66 in the rear module body 16 and also is shown the specialized frame 18. The second purpose is to allow a 90 degree rotation of the jack 80, 82, 84, and 86 from the horizontally stowed position shown in FIG. 2, to the vertically deployed position shown in FIG. 3 which would allow the jacks 80, 82, 84, and 86 to lift the rear module bodies 16 from the specialized frame 18. The third purpose is to create a clearance 90 from the rear wheels 29. The fourth purpose would allow supporting of weight of the rear module body 16 when detached from the specialized frame 18. This would allow for free standing of the rear module body 16 as depicted in FIG. 4. After the rear module body 16 is detached from the specialized frame 18 behind the driving cab 14, the base vehicle 12, including the driving cab 14 can be driven away to another free standing rear module body 16.

When attaching the rear module bodies 16 to the driving cab 14 via specialized frame 18, the frame channels 44 and 46 on the rear module body 16 and the specialized frame 18 on the driving cab 14 will first be aligned. Then, second, when lowering rear module bodies 16 onto the specialized frame 18, the slope or incline segments 24 and 26 of the specialized frame 18 in front of the rear axle 28 will create a forward push on the rear module body 16 towards the driving cab 14, allowing for a tight fit between the rear module body 16 and the driving cab 14 at junction 42. This forward push may be facilitated by lubricating the interior surface of the frame channels 44 and 46 or the exterior, most particularly the upper surfaces, of the specialized frame 18, most particularly at the slope or incline segments 24 and 26, with graphite, oil or grease, as well as making the interacting surfaces relatively smooth. The rear 38 of the driving cab 14 will have a slight angle “A” going forward from bottom 39 to top 37 as depicted in FIG. 1 this angle “A” will match the angle “B” on the front 40 of the rear module body 16. Preferably, the angles “A” and “B” are substantially the same, i.e. matching, and are from about 1 degree to about 20 degrees relative to vertical, more preferably from about 3 degrees to about 10 degrees relative to vertical, and most preferably from about 4 degrees to about 6 degrees relative to vertical. The angle of junction 42 allows for complete vertical lifting during separation and also would ease friction between the weather-stripping 43 while engaging and disengaging the rear module bodies from the drive cab 14. The weather-stripping 43 may be carried on the driving cab 14 or the rear module body 16 or both and enhances the seal at junction 42. Effective weather-stripping is readily available in the automotive industry.

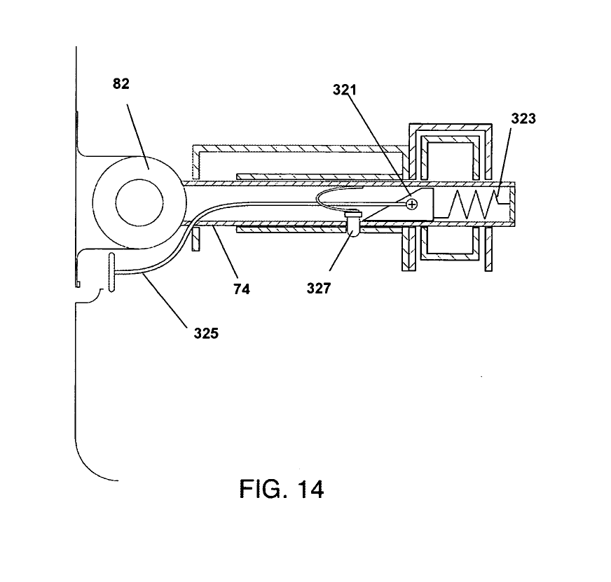

The rear module bodies 16 will have four compartments 92, 94, 96, and 98 which will each house one of the sliding lock jacks assemblies 64, 66, 68 and 70. The sliding lock jacks assemblies 64, 66, 68, and 70 will each have body panels 102, 104, 106, and 108 attached on the outside as depicted in FIG. 3. Which body panels 102, 104, 106, and 108, when closed to the rear module body, will conceal the compartments 92, 94, 96, and 98 and remainder of the sliding lock jacks assemblies. In one embodiment, on the insides of the compartments 92, 94, 96, and 98 there will be manual lever mechanisms 112, 114, 116, and 118 that locks and unlocks the locking tubes 72, 74, 76, 78 of the sliding lock jacks assemblies 64, 66, 68, and 70. Another alternative embodiment is depicted schematically in FIG. 14. An internal sliding wedge 321 is urged centrally by a spring 323 and can be pulled outwardly by a handled control cable or rope 325. The wedge 321 disengages a spring pin 327 from mutually aligned apertures in slide tube 74 and another frame mounted tube, allowing the slide tube 74 to extend outwardly and rotate so as to disengage from the frame 18. Preferably, spring pin 327 is guided by a track or pathway in the frame mounted tube. Preferably a second aperture is provided to allow the spring pin 327 to engage in the extended and jack deployed condition. The release mechanism of this embodiment allows the jack 82 to be deployed from the module body and rotated to vertical, such that the module body may be lifted by the jack. Note that, in contrast to the recesses of the McCarthy camper discussed in the background for the present invention, the compartments 92, 94, 96 and 98 need only have a vertical dimension sufficient to accommodate the diameter of the jacks, whereas the McCarthy jacks need to be accommodated over their entire retracted extent.

This invention of a base vehicle 12 with a driver control region, for example, a driving cab 14 and with a specialized frame 18 forming part of a system that would allow fast and easy removal of rear module bodies 16 is also convenient. There would be no tools necessary for removal or attachment of rear module bodies 16. The invention is simple enough for a person with little mechanical knowledge to use the sliding lock jacks assemblies 64, 66, 68, and 70. One can transform the quick changing rear module body vehicle 10 from one type to another, i.e.: regular cab pickup truck, extended cab pickup, crew cab pickup, flat bed truck, suv, van, crossover, camper, etc. in just minutes.

The present invention, in a preferred embodiment, is an interchangeable rear modular body vehicle. This invention would have a base vehicle 12 including a driving cab 14 and also including everything needed to drive the base vehicle 12, at least an engine, at least four wheels and a gas tank. The rear 38 of the driving cab 14 behind the driver and passenger doors 15 would be open to the back allowing many different rear body configurations or variation of the rear module bodies 16 to be attached to the specialized frame 18 behind the driving cab 14. This invention with the specialized frame 18 and various designs for rear module bodies 16 would allow for fast and easy attachment and removal of rear modular bodies 16. This embodiment preferably includes four sliding lock jacks assemblies 64, 66, 68, and 70 which will be attached to the rear module bodies 16 that will allow these rear module bodies 16 to be removed and or attached to the specialized frame 18. Jacks 80, 82, 84, and 86, which are part of the sliding lock jack assemblies 64, 66, 68, and 70 will manually deploy from compartments 92, 94, 96, and 98 in the rear module bodies 16 by pulling out and disconnecting the rear module body 16 from the specialized frame 18 then rotating 90 degrees allowing jacks 80, 82, 84, and 86 to lift the rear module body 16 off of the specialized frame 18. In a preferred embodiment, jacks 80, 82, 84, and 86 will be electrically powered with a control switch 120 located in one of the compartments 92, 94, 96, and 98. Once the rear body module 16 and the specialized frame 18 are separated, then the electrical power will need to be disconnected using a quick disconnect feature 122. After the electrical power is disconnected, the driving cab 14 is used to drive the base vehicle to another rear module body 16. To reattach another rear module body 16, position the base vehicle 12 under the another rear module body 16 aligning the specialized frame 18 with the frame channels 44 and 46. Connect electric power and retract jacks 80, 82, 84, and 86 which will lower the rear module body 16 onto the specialized frame 18. Once jacks 80, 82, 84, and 86 are fully retracted, the rear module body 16 will need to be locked to the specialized frame 18 rearward of the driving cab 14 by manually rotating jacks 80, 82, 84, 86 by 90 degrees (so as to place them in a horizontal condition, suitable for movement into their respective compartments 92, 94, 96, and 98) and by pushing jacks 80, 82, 84, and 86 back into stored position which also locks the rear module body 16 to the specialized frame 18.

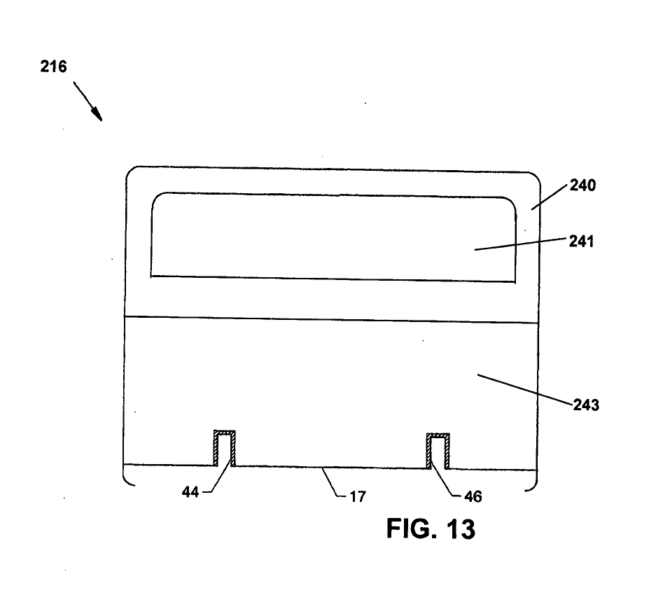

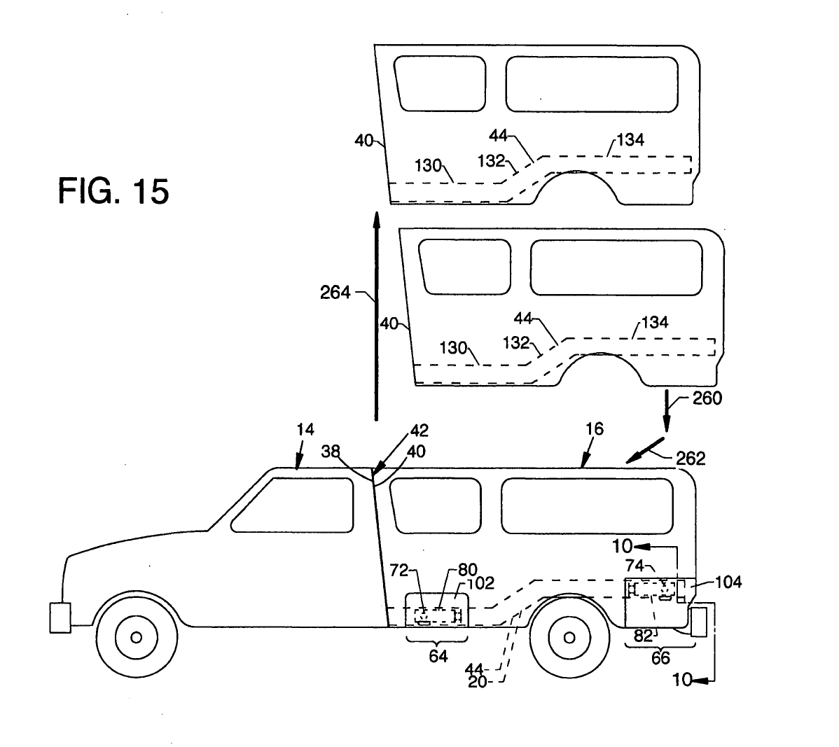

As shown schematically in FIG. 12, another rear module body 216 is a pick-up box configuration. Most noteably, the front 240 of rear module body 216 forms junction 42 at the open rear 38 of driving cab 14. The pick-up box styled rear module body 216 or early discussed passenger rear module body 16 both cause a seal by weather-stripping at junction 42, which is a tight fit due to the interaction of the frame channels 44 and 46 with the specialized frame 18 and the forward push imparted during lowering of the rear body modules 16 or 216 onto the base vehicle 12. As schematically shown in FIG. 13, the pick-up box configured rear module body 216 has a front 240 which, optionally but preferably, includes a rear window 241 and could easy include a top brake light (not shown). Wiring and control and connection of a rearwardly directed top brake light on the rearward face of front 240 is within the skill of the art. A tailgate or removable tailgate may be present at the rear of the pick-up box rear module body 216. Also, as with rear module body 16, rear body module 216 is lifted vertically off of the base vehicle 12, with the slightly angled junction 42 parting easily, with minimal friction on the weather-stripping. In both cases, it should be emphasized that the interaction of specialized frame 18 with the contouring and conforming frame channels 44 and 46 causes the installation pathway to be different from the removal pathway, as schematically depicted in FIG. 15. That is, during installation, the rear module bodies 16 or 216 are lowered first vertically (downward vertical path arrow 260), then pushed forward by the slope and or incline interactions to form the tight fit at junction 42, generally following the matched angles of the inclines or slopes 24, 26 and channel frames 44 and 46 interacting therewith (downward sloped path arrow 262). However, in removal, the pathway is a single vertical path (upward vertical path arrow 264). Although the pathway in installation and removal has been described in simple terms, it will of course be recognized by those of ordinary skill that some modification of the simple paths may result from action of suspensions associated with the base vehicle and such will be modulated by the relative loading of the rear module body weight onto the base vehicle, depending primarily on the springs and tires thereof. Besides being useful for cargo transport of gravel or hay or grain, the pick-up style vehicle of FIG. 12 might also be used to carry a wheel-less pick-up truck camper such as taught by McCarthy in U.S. Pat. No. 7,722,110. However, in the opinion of the inventor, it is to be expected that only pre-existing wheel-less pick-up truck campers would be so carried and that a camper body style rear body module, including the frame channels, locking tube mechanism, and sliding lock jack assemblies would be available or adaptable to the present system and implement a tight fit junction at the rear of a base vehicle driving cab. Such a new camper would preferably include the capability of persons passing between the driving cab and the camper through the sealed junction of tight fit angle “A” and angle “B”.

The present invention may be adapted to and applied to modified body-on-frame passenger sized vehicles, light duty trucks such as pickup trucks, larger straight body trucks, and many other framed vehicles, such as off-road vehicles including 2 wheel drive, 4×4 drive, all wheel drive (AWD), 6×6 drive and 8×8 drive vehicles, military vehicles which have a frame and which would benefit from enhanced versatility, all terrain vehicles (ATV), utility terrain vehicles (UTV), skid steer vehicles, tracked vehicles, agricultural vehicles and so forth. This wide range of vehicles may modified to implement the invention by redesigning their frames to include an appropriately sloped portion in their frames so as to result in the specialized frame invention featured in FIG. 1 and then also providing an array of exchangeable rear module bodies with frame channels which interact with the frames to provide a two path installation and a single path removal, as schematically depicted in FIG. 15.

On all but perhaps the smallest ATV size base vehicles, locking slide jack assemblies would be used for the purpose of installing, uninstalling and locking/unlocking. Alternatively, weight and expense might be reduced by using separable jacks which could be left a central point with the plurality of rear module bodies which were not in use at the time, and such separable jacks used to raise or lower rear module bodies during the installation/assembly step or removal/disassembly step. On the smallest ATV sized vehicles, one or two people may manually lift or lower a small, light rear module body one the specialized frame of the ATV, and this ability might be enhanced by eliminating the weight of the jacks and possibly the concealment panels from the sliding lock jack assemblies, while still retaining a simple locking mechanism of locking tubes or pins fastening the small, light rear module body to the specialized ATV frame. In a military ATV, such a small, light rear module body might be used a gun mount, with the gun being separately attached or detached to the gun mount to keep the weight of the small, light rear module body manageable for manual lifting or lowering. Alternatively, ammunition transport or combined ammunition transport and gun mounts might be provided according to the present invention. In the case of an ATV or other vehicle lacking a driving cab, a driver control region still is present on the vehicle. In such a situation lacking a driving cab, a tight fit of the rear module body to a driving cab is inappropriate. However, a desired position rearward of the driver control region still is present. The inclined segment and/or sloped specialized frame still may be employed to facilitate installation and positioning in such a desired position. Optionally, but preferably, a stop may be installed on the specialized frame to limit forward movement of rear module body and arrest its motion at the desired position. Optionally, such a stop might be a welded projection or a bolt head projecting from the specialized frame. It is further possible, that a removable bolt head might serve as a stop at more than one position to correspond to desired positions for different types of rear module bodies, for example, when two rear module bodies have distinct desired positions due to distinct weight balance.

Alternatively, and particularly preferred when low or limited production numbers are involved in the base vehicle, an upper surface profile on frame rails of the base vehicle may be achieved by a single adaptor or a plurality of adaptors fastened or applied onto the top of the base vehicle's stock frame rails. Such adaptor or adaptors would provide, on the upper surface, a sloping segment or portion rising from the profile of a base vehicle frame resulting, from rearward to forward, in an elevated rear segment connected to a sloping segment leading forwardly and downwardly to a mid-segment. The mid-segment could be either the original stock frame, if suitable, or a portion of the adaptor or adaptors. The lower surface of the adaptor or adaptors would preferably conform to the upper surface of the stock frame of the base vehicle. The resulting specialized frame on the adapted stock frame base vehicle would interact with a conforming frame channel or frame channels on a rear module body to be installed or removed therefrom, where the rear module body is one of two or more rear module bodies with various distinct configurations and purposed, such as a pick-up style cargo box and a passenger compartment. More preferably, a variety of adaptor or adaptors could be used with a variety of different stock frames of base vehicle while providing a more limited number of upper profiles, thereby allowing rear module bodies to be standardized for use with a variety of base vehicle frames though appropriate adaptor or adaptors selection. Preferably, the holes or apertures for locking of the specialized frame are provided by the adaptors, thereby avoiding possible warranty issues with the manufactures of the stock frames. Alternatively, stock frames might be altered to provide locking holes or apertures.

In another alternative embodiment, the frame of many vehicles can be altered to conform to the system of this invention by adding an adapter to the stock frame as explained immediately above, but without inclusion of the open rear of the driving cab. For example, a chassis cab from the main truck manufacturers typically has a generally flat or level frame extending rearward from behind a closed back cab. Fastening an adapter that includes at least the slope or incline segment taught herein provides an effective specialized frame which can then accept installation of a rear module body. In such a system, the cab may be left as supplied by the manufacturer, with the rear of the cab closed. In this alternative embodiment, the “tight fit” between cab and rear body module is impractical and closed fronts on the rear module bodies must be provided. A simple front panel closure, optionally with a window such as shown in FIG. 13 might be added to adapt the open front rear module bodies for such usage, taking into account the angle “B”. A suitable spacing or gap is left between the cab and the rear module body, as is typical for installed prior art aftermarket truck bodies, but while still taking into account the angle “B” to avoid unwanted contact high up on the rear of the cab of the chassis cab. In this alternative embodiment, the frame channels and the front of the rear module body must then be provided with a stop or preventer to index or arrest the forward push imparted during installation, so as to preserve a suitable spacing or gap. Alternatively, the back of the cab of the chassis cab could be opened, at an angle “A” as explained previously, and the full range of rear module bodies installed and exchanged, including the open front rear module bodies configured for two or three or more rows of passenger seating, with angle “B” at the open front tightly fit and forming a junction, sealed against angle “A” of the cab.

The present invention has been described in connection with certain embodiments. It is to be understood, however, that the description given herein has been given for the purpose of explaining and illustrating the invention and are not intended to limit the scope of the invention. It is to be further understood that changes and modifications to the descriptions given herein will occur to those skilled in the art. Therefore, the scope of the invention should be limited only by the scope of the following claims and their legal equivalents.

What is claimed is:

1. A quick changing rear module body vehicle, comprising:
a base vehicle, the base vehicle including a specialized frame extending rearward from a driver control region, the specialized frame having a slope segment;
a rear module body, the rear module body having a bottom and a frame channel located on the bottom of the of the rear module body, the frame channel having U-shape oriented with an open bottom and contoured to fit the slope segment of the specialized frame;
wherein, when the rear module body is vertically lowered onto the specialized frame of the base vehicle, the slope segment of the specialized frame creates a forward push of the rear module body toward the driver control region, resulting in a desired position of the rear module body on the specialized frame rearward of the driver control region and the rear module body.

2. The quick changing rear module body vehicle of claim 1 wherein the base vehicle is selected from the group consisting of 2 wheel drive chassis-cab truck, 4×4 drive chassis-cab truck, all wheel drive chassis-cab truck, 6×6 drive trucks, 8×8 drive trucks, all-terrain vehicle (ATV), utility-terrain-vehicle, skid-steer vehicles, track vehicles, agricultural vehicles, and military vehicles.

3. The quick changing rear module body vehicle of claim 1, wherein when the rear module body is vertically lowered onto the frame, a forward push created by the slope segment of the specialized frame when the rear module body is lowered onto the specialized frame positions the rear body module in the desired position.

4. The quick changing rear module body of claim 1, wherein the rear module bodies of the plurality of rear module bodies have configurations selected from group consisting of: regular cab pickup truck, extended cab pickup, crew cab pickup, flat bed truck, suv, van, crossover, and camper.

5. A method of assembly for a vehicle, the method comprising the steps of:
providing a base vehicle having a driver control region and a specialized frame having two rectangular tubular rails, each with a slope segment;
providing a rear module body with a bottom having two frame channels, the frame channels having a U-shape with an open bottom and contoured to fit the slope segments of the rails of the specialized frame;
aligning the frame channels over the rails of the specialized frame;
lowering the rear module body onto the specialized frame; and,
creating a forward push by the slope segments interacting with the contoured frame channels, such that a desired position results for the rear module body on the specialized frame.

6. The method of claim 5, further comprising the steps of:
providing a stop to limit motion resulting from the forward push; and
allowing the stop to limit the motion of the rear body module, subsequent to the forward push, such that the desired position is not passed by the rear module body.

7. The method of claim 6 wherein driver control region is a driver cab and the stop is provided by the rear of the driver cab.

8. The method of claim 6 and wherein the stop is a bolt head.

9. The method of claim 8 and wherein the bolt head is removable.

10. The method of claim 6, wherein the rear module body is a member of a plurality of distinct rear module bodies and wherein the stop is coordinated with the particular rear module body being assembled, so as to place the particular rear module module in a desired location for the particular rear module body of the plurality of rear module bodies.

11. An adapter for attachment to a rail of a vehicle frame, the adapter comprising:
a rail interface;
a slope segment elevated above the rail interface;
means for attaching the adapter to the rail;
wherein, when a pair of the adapters are attached to the rails of a frame, the pair of adapters provide an adapted specialized frame, having two adapted frame rails, each adapted frame rail having a slope segment, the adapted specialized frame receptive of a rear module body with a bottom having two frame channels, the frame channels having a U-shape with an open bottom and contoured to fit the slope segments of the adapted frame rails of the adapted specialized frame, such that when the frame channels are aligned over the adapted frame rails and lowered onto the specialized frame, a forward push by the slope segments interacting with the contoured frame channels, such that a desired position results for the rear module body on the adapted specialized frame.
